(19) United States
(12) Patent Application Publication
(10) Pub. No.: US 2011/0011206 A1
(43) Pub. Date: Jan. 20, 2011

(54) DRIVELINE YOKE WITH BRAKE ROTOR

(76) Inventors: Donn C. Knight, Troy, MI (US); Kenneth Pietila, Howell, MI (US); Florin Patrascu, West Bloomfield, MI (US); Christopher Steele, Lake Orion, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/502,591

(22) Filed: Jul. 14, 2009

(51) Int. Cl. F16H 37/06; F16D 65/12; F16C 3/00; F16D 3/84; B21D 53/88

(52) U.S. Cl. 74/665 T; 188/218 XL; 464/182; 464/178; 29/897.2

(57) ABSTRACT

A driveline yoke is integrally formed as one-piece with a brake rotor. At least one caliper includes a friction element that selectively engages the brake rotor. In one example, the yoke is coupled to a front output of a transfer case and the caliper is mounted to a housing of the transfer case with the friction element engaging a braking surface on the brake rotor in response to a parking brake request.

### TECHNICAL FIELD

This invention generally relates to a parking brake rotor that has been integrated into a driveline yoke.

### BACKGROUND OF THE INVENTION

Parking brakes are often difficult to package along vehicle drivelines. A typical driveline is comprised of an engine and transmission that provide driving input to a transfer case. The transfer case typically has a first driving output to drive a rear differential of a rear axle and a second driving output to selectively drive a front differential.

It is often difficult to mount the parking to the front and rear differentials due to interference with other vehicle components. Similarly, it is difficult to mount the parking brake near the transfer case due to limited packaging restraints. Additionally, installing the parking brake at locations along the driveline can adversely affect driveline angles.

### SUMMARY OF THE INVENTION

A driveline yoke is integrally formed as one-piece with a brake rotor. Thus, the yoke and brake rotor comprise a single-piece, unitary, monolithic structure having a continuous, uninterrupted surface.

In one example, the brake rotor and yoke are formed as a single-piece component using a casting process.

In one example, at least one caliper includes a friction element that selectively engages the brake rotor. The friction element engages a braking surface on the brake rotor in response to a parking brake request.

In one example, the yoke is coupled to an output of a transfer case and the at least one caliper is mounted to a housing of the transfer case.

These and other features of the present invention can be best understood from the following specification and drawings, the following of which is a brief description.

### BRIEF DESCRIPTION OF THE DRAWINGS

FIG. 1 is a schematic representation of one example of a vehicle drivetrain.

FIG. 2 is a perspective view of a transfer case and a single-piece yoke-rotor.

FIG. 3 is a cross-sectional view of the single-piece yoke-rotor.

FIG. 4 is a schematic end view of the yoke-rotor showing optional caliper configurations.

FIG. 5 is a schematic view showing an optional mounting location for the yoke-rotor.

### DETAILED DESCRIPTION OF THE PREFERRED EMBODIMENT

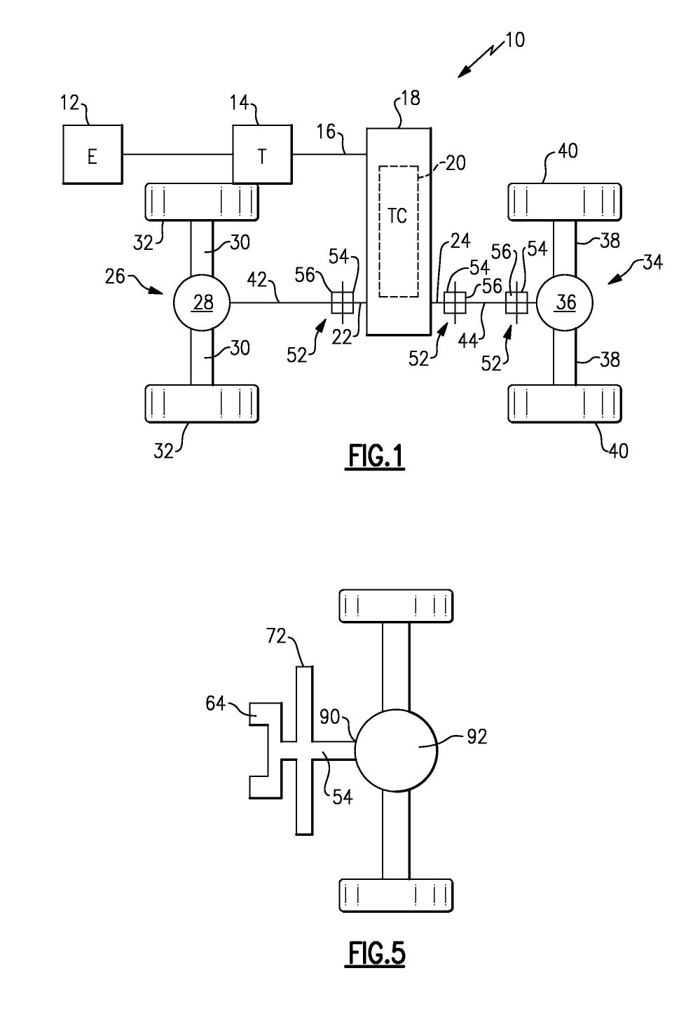

FIG. 1 illustrates one example of a vehicle drivetrain 10. The vehicle drivetrain 10 includes a power source 12, such as an electric motor or combustion engine, which provides driving input to a transmission 14. The transmission 14 provides driving input to an input shaft 16 of a transfer case 18. The transfer case 18 includes a gear assembly 20 that transfers driving input from the input shaft 16 to a front output shaft 22 and a rear output shaft 24.

The front output shaft 22 is either permanently coupled to, or can be selectively coupled to, a front drive axle 26. The front drive axle 26 is typically a steer axle; however, other types of axles could also be used for the front axle. The front drive axle 26 includes a front differential 28 that drives a pair of front axle shafts 30, which in turn drive a pair of front wheels 32.

The rear output shaft 24 drives a rear drive axle 34, which can be a single drive axle as shown, or could comprise a tandem axle or another type of axle configuration. The rear drive axle 34 includes a rear differential 36 that drives a pair of rear axle shafts 38, which in turn drive a pair of rear wheels 40.

A first driveshaft 42 connects the front output shaft 22 to the front drive axle 26 and a second driveshaft 44 connects the rear output shaft 24 to the rear drive axle 34. Typically, connections between shafts and the various drivetrain components are provided by yoke assemblies.

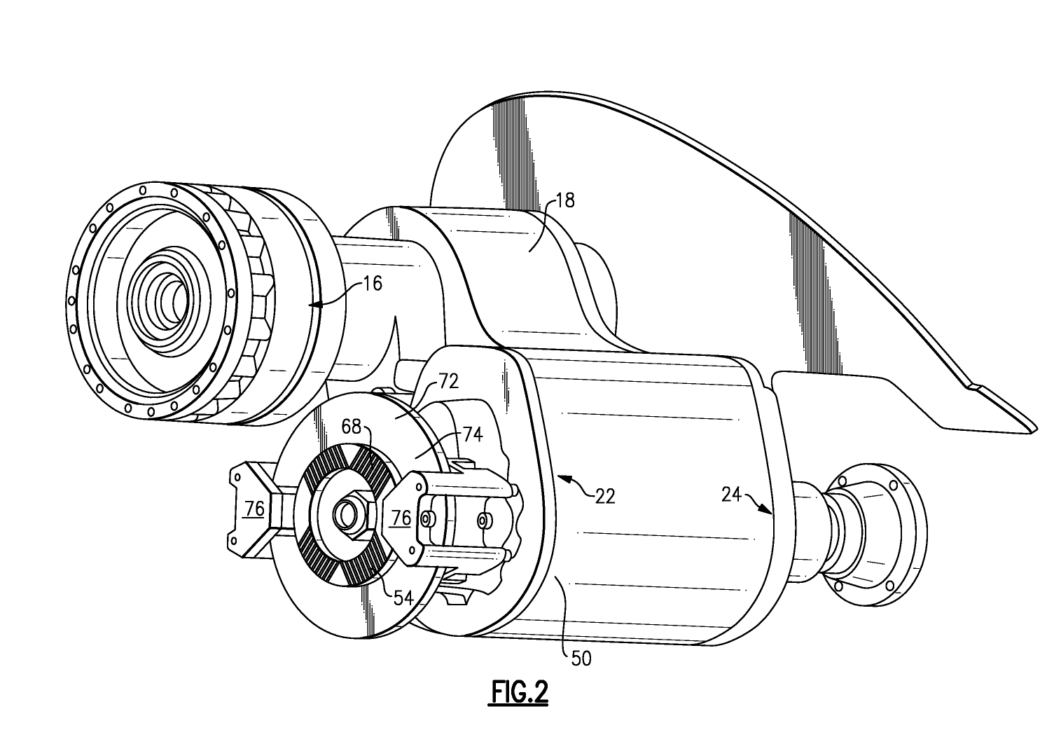

FIG. 2 shows the transfer case 18 in greater detail. The transfer case includes a housing 50 that encloses the gear assembly 20 (FIG. 1). The front output shaft 22 and the rear output shaft 24 extend out from opposing sides of the housing 50. The front 22 and rear 24 output shafts each are coupled to a yoke assembly 52 (FIG. 1). The yoke assembly 52 includes a first yoke 54 that is coupled to the respective output shaft and a mating second yoke 56 that is coupled to a respective one of the rotating driveshafts 42, 44 as shown in FIG. 1.

An example of the first yoke 54 is shown in FIG. 3. The first yoke 54 includes a shaft body 60 at one yoke end 62 and a yoke connection interface 64 at an opposite yoke end 66. The yoke connection interface 64 is coupled to the mating second yoke 56 to rotatably connect the adjoining drivetrain components together. In the example shown in FIG. 2, the front output shaft 22 of the transfer case 18 is rotatably connected to the first driveshaft 42.

In the example shown in FIG. 3, the yoke connection interface 64 comprises a u-joint connection interface; however, other types of yoke connection interfaces could also be formed at the yoke end 66. For example, a splined flange connection interface 68 is shown in FIG. 2.

The shaft body 60 at yoke end 62 includes a splined connection interface 70 for connection to the front output shaft 22 of the transfer case 18; however, other types of connection interfaces could also be used. At a position axially between the splined connection interface 70 and the yoke connection interface 64, the first yoke 54 includes a rotor 72 that is integrally formed as one-piece with the first yoke 64. Thus, the first yoke 54 and rotor 72 comprise a unitary, monolithic, single piece component having a continuous, uninterrupted surface.

The rotor 72 defines a braking surface 74 that is selectively engaged by at least one caliper 76. In the example shown, the caliper 76 is mounted to the housing 50 of the transfer case 18. However, the caliper 76 could be mounted to other non-rotating structures, such as a vehicle frame for example. The caliper 76 selectively engages the braking surface 74 in response to a parking brake request.

The parking brake request is a signal that is typically generated by a vehicle operator. The signal can be any type of signal, and movement of the caliper 76 to engage the rotor 72 can be initiated hydraulically, pneumatically, or electrically for example.

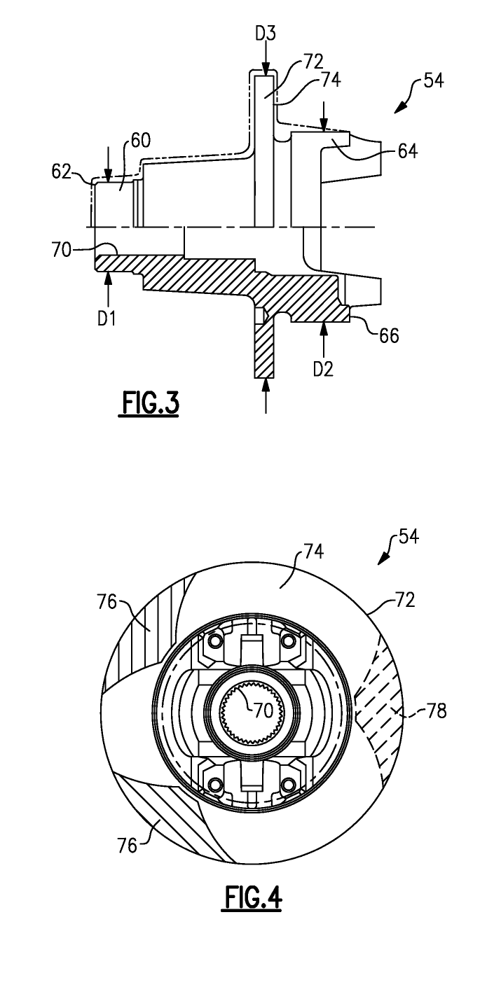

In the example shown in FIG. 2, two calipers 76 are used to engage the braking surface 74 on opposing sides of the rotor 72. It should be understood that calipers 76 could be located at different locations relative to the rotor 72 as shown in FIG. 4. Further, more than two calipers 76 could also be utilized as indicated by the additional caliper 78 shown in FIG. 4.

The shaft body 60 is defined by a first diameter D1 at the yoke end 62 and is defined by a second diameter D2 at the yoke end 66 that is greater than the first diameter D1. The rotor 72 is defined by a third diameter D3 that is greater than the second diameter. Transition surfaces of varying diameters extend from the shaft body 60 to the rotor 72, and from the rotor 72, to the yoke connection interface 64.

By integrally forming the rotor 72 with the yoke 54 a compact parking brake configuration is provided that is easily incorporated into a vehicle driveline. As the yoke 54 has a splined connection interface 70, the rotor 72 is easily installed without requiring any fastening elements. Also, because fasteners are not required for rotor attachment, the brake surface area is maximized without having to increase the rotor diameter.

Further, in comparison to prior parking brakes, there are fewer components which reduces cost and weight. Also, because the number of components are reduced, the balancing of the brake is more easily accomplished. In prior designs, multiple brake components had to be individually balanced. With the configuration described above, only one component needs to be balanced, i.e. only the yoke-rotor needs to be balanced.

Finally, the integrated rotor and yoke does not adversely affect driveshaft lengths, which in turn preserves proper driveshaft angles. Specifically, the compact arrangement maintains driveline angles at less than six degrees.

It should be understood that the drivetrain 10 shown in FIG. 1 is merely one example of a drivetrain, and that other drivetrain configurations including fewer or more components could also be utilized with the subject yoke-rotor. Further, while the integrated yoke-rotor is shown as being positioned at the front output from the transfer case, the yoke 54 with the integrated rotor 72 could be positioned at other locations, such as an input 90 to a drive axle 92 as shown in FIG. 5. Other possible locations would be at an input to the transfer case or a rear output from the transfer case, for example.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle driveline component comprising:
a yoke for coupling a first rotating driveline component to a second rotating driveline component; and
a rotor integrally formed as one-piece with said yoke, said rotor defining a braking surface to be engaged by a non-rotating brake component.

2. The vehicle driveline component according to claim 1 wherein said yoke has a shaft body at a first end for connection to the first rotating driveline component and has a first yoke connection interface at an opposite, second end for connection to a second yoke connection interface associated with the second rotating driveline component.

3. The vehicle driveline component according to claim 2 wherein said first and said second yoke connection interfaces comprise one of a u-joint or splined end face connection.

4. The vehicle driveline component according to claim 2 wherein said first end comprises a splined connection interface.

5. The vehicle driveline component according to claim 2 wherein said shaft body is defined by a first diameter, said first yoke connection interface is defined by a second diameter greater than said first diameter, and said rotor is defined by a third diameter greater than said second diameter, and wherein said rotor is positioned axially between said first yoke connection interface and said first end.

6. The vehicle driveline component according to claim 2 wherein said rotor is fixed for rotation with said first rotating driveline component without fasteners.

7. The vehicle driveline component according to claim 2 wherein said first rotating component is positioned within a non-rotating housing and including at least one caliper mounted to said housing, said at least one caliper having a friction element to selectively engage said rotor.

8. The vehicle driveline component according to claim 7 wherein said housing comprises a transfer case housing and wherein said first rotating driveline component comprises an output shaft from a transfer case.

9. The vehicle driveline component according to claim 7 wherein said friction element engages a braking surface on said rotor in response to a parking brake request.

10. A vehicle driveline comprising:
a transfer case having a housing, said transfer case including an input to be rotatably coupled to an output from a power source, a front output to drive a front axle, and a rear output to drive a rear axle;
a yoke and rotor integrally formed with said yoke, said yoke having a shaft end that is coupled to one of said input, front output, or rear output; and
at least one caliper mounted to said housing and including a friction element that engages said rotor.

11. The vehicle driveline according to claim 10 wherein said yoke and rotor comprise a single-piece component with a continuous, uninterrupted surface.

12. The vehicle driveline according to claim 11 wherein said shaft end is coupled to said front output.

13. The vehicle driveline according to claim 11 wherein said friction element selectively engages a braking surface on said rotor in response to a parking brake request.

14. A method of forming a driveline component comprising the steps of:
providing a yoke having one end for connection to a rotating driveline component and an opposite end to be coupled to a mating yoke; and
integrally forming a rotor with the yoke to provide a single-piece yoke-rotor component.

15. The method according to claim 14 including casting the yoke and rotor as a sing-piece yoke-rotor component.
